(19) United States
(12) Patent Application Publication
(10) Pub. No.: US 2017/0298676 A1
(43) Pub. Date: Oct. 19, 2017

(54) SLIDING DOOR WEEP SILL ASSEMBLY

(71) Applicant: KOLBE & KOLBE MILLWORK CO., INC., WAUSAU, WI (US)

(72) Inventors: Brian Wilhelm, Wausu, WI (US); Robin T. De Lonay, Merrill, WI (US); Scott Hintz, Wausau, WI (US); Tom Beyerl, Wausau, WI (US)

(21) Appl. No.: 15/483,243

(22) Filed: Apr. 10, 2017

Related U.S. Application Data
(60) Provisional application No. 62/322,370, filed on Apr. 14, 2016.

(51) Int. Cl. E06B 1/70; E05D 15/06

(52) U.S. Cl. CPC E06B 1/70; E05D 15/0665; E05Y 2900/132

(57) ABSTRACT

A weep sill assembly includes an elongated sill base, a first floor within the sill base, and a drain conduit. The elongated sill base includes a top opening configured for fluid ingress. The first floor divides an interior of the sill base into an upper chamber and a lower chamber, wherein the floor includes a first aperture that provides fluid communication between the upper chamber and the lower chamber. The drain conduit is in fluid communication with the lower chamber. In another aspect, a sliding door assembly includes a header configured for attachment to a wall, a weep sill assembly, and a door panel configured for slidable engagement with the header and with the weep sill assembly.

### CROSS REFERENCE TO RELATED APPLICATION

This application claims the benefit of priority from U.S. Provisional Patent Application No. 62/322,370, filed Apr. 14, 2016, which is fully incorporated herein by reference.

### BACKGROUND

Sliding doors are often used at building openings where it is desirable to provide convenient access to the outdoors. Moreover, sliding doors are often provided with large panes of window glass, allowing for a wide viewing expanse through the doors. Such sliding doors are commonly used at an egress to a patio or other outdoor living space.

Because one or more door panels slide past each other on a set of tracks, commonly attached to the building at the floor and door header, such sliding doors advantageously do not require additional clearance to the interior or exterior, as would a swinging door panel.

When closed, such sliding doors act as a wall between the interior and exterior of the building. As such, construction of the sliding door assembly includes features to keep exterior environmental elements, such as precipitation, outside of the door assembly. Additionally, when a door panel of a sliding door assembly is opened, some water or other environmental contaminants may be carried onto the floor track, such as by wind or by transportation on the soles of a user's shoes. A weep sill assembly is provided on such sliding door tracks to collect water deposited thereon and drain it to a suitable location.

### SUMMARY

In one aspect, a weep sill assembly includes an elongated sill base, a first floor within the sill base, and a drain conduit. The elongated sill base includes a top opening configured for fluid ingress. The first floor divides an interior of the sill base into an upper chamber and a lower chamber, wherein the floor includes a first aperture that provides fluid communication between the upper chamber and the lower chamber. The drain conduit is in fluid communication with the lower chamber.

In another aspect, a sliding door assembly includes a header configured for attachment to a wall, a weep sill assembly, and a door panel configured for slidable engagement with the header and with the weep sill assembly. The weep sill assembly includes an elongated sill base, a first floor within the sill base, and a drain conduit. The elongated sill base includes a top opening configured for fluid ingress. The first floor divides an interior of the sill base into an upper chamber and a lower chamber, wherein the floor includes a first aperture that provides fluid communication between the upper chamber and the lower chamber. The drain conduit is in fluid communication with the lower chamber.

This disclosure, in its various combinations, either in apparatus or method form, may also be characterized by the following listing of items:
1. A weep sill assembly including:
   an elongated sill base including a top opening configured for fluid ingress;
   a first floor within the sill base that divides an interior of the sill base into an upper chamber and a lower chamber, wherein the floor includes a first aperture that provides fluid communication between the upper chamber and the lower chamber; and
   a drain conduit in fluid communication with the lower chamber.
2. The weep sill assembly of item 1 further including:
   a sill roller cap disposed in the top opening.
3. The weep sill assembly of item 2, wherein the sill roller cap includes a plurality of second apertures configured for fluid ingress.
4. The weep sill assembly of any of items 2-3 further including an end cap configured for attachment to an end of the sill base.
5. The weep sill assembly of item 4, wherein the end cap includes an insert configured for insertion into the end of the sill base.
6. The weep sill assembly of any of items 4-5, wherein the sill base includes two opposed upper walls and two opposed lower walls, and wherein the insert is configured to have a shape corresponding to an interior of the sill roller cap and an interior of the upper walls and an interior of the lower walls.
7. The weep sill assembly of any of items 4-6, wherein the end cap includes a port that provides for fluid communication between the drain conduit and the lower chamber.
8. The weep sill assembly of any of items 1-7, wherein the first aperture is an elongated slot located proximate an end of the sill base.
9. The weep sill assembly of any of items 1-8, further including a second floor that defines a bottom of the lower chamber.
10. The weep sill assembly of item 9, wherein the sill base further includes:
   two opposed lower walls; and
   a flange that extends from one of the lower walls and is co-planar with the second floor.
11. A sliding door assembly including:
   a header configured for attachment to a wall;
   a weep sill assembly including:
      an elongated sill base including a top opening configured for fluid ingress;
      a first floor within the sill base that divides an interior of the sill base into an upper chamber and a lower chamber, wherein the floor includes a first aperture that provides fluid communication between the upper chamber and the lower chamber; and
      a drain conduit in fluid communication with the lower chamber; and
   a door panel configured for slidable engagement with the header and with the weep sill assembly.
12. The sliding door assembly of item 11 further including a sill roller cap disposed in the top opening and including a ridge, wherein the door panel further includes a wheel configured for rolling engagement with the ridge.
13. The sliding door assembly of item 12, wherein the sill roller cap includes a plurality of second apertures configured for fluid ingress.
14. The sliding door assembly of any of items 12-13 further including an end cap configured for attachment to an end of the sill base.
15. The sliding door assembly of item 14, wherein the end cap includes an insert configured for insertion into the end of the sill base.
16. The sliding door assembly of any of items 14-15, wherein the sill base includes two opposed upper walls and two opposed lower walls, and wherein the insert is configured to have a shape corresponding to an interior of the sill roller cap and an interior of the upper walls and an interior of the lower walls.
17. The sliding door assembly of any of items 14-16, wherein the end cap includes a port that provides for fluid communication between the drain conduit and the lower chamber.
18. The sliding door assembly of any of items 11-17, wherein the first aperture is an elongated slot located proximate an end of the sill base.
19. The sliding door assembly of any of items 11-18, further including a second floor that defines a bottom of the lower chamber.
20. The sliding door assembly of item 19, wherein the sill base further includes:
   two opposed lower walls; and
   a flange that extends from one of the lower walls and is co-planar with the second floor.

This summary is provided to introduce concepts in simplified form that are further described below in the Detailed Description. This summary is not intended to identify key features or essential features of the disclosed or claimed subject matter and is not intended to describe each disclosed embodiment or every implementation of the disclosed or claimed subject matter. Specifically, features disclosed herein with respect to one embodiment may be equally applicable to another. Further, this summary is not intended to be used as an aid in determining the scope of the claimed subject matter. Many other novel advantages, features, and relationships will become apparent as this description proceeds. The figures and the description that follow more particularly exemplify illustrative embodiments.

### BRIEF DESCRIPTION OF THE DRAWINGS

The disclosed subject matter will be further explained with reference to the attached figures, wherein like structure or system elements are referred to by like reference numerals throughout the several views. Moreover, analogous structures may be indexed in increments of one hundred. It is contemplated that all descriptions are applicable to like and analogous structures throughout the several embodiments.

FIG. 1 is a partial perspective view of one end of an exemplary weep sill assembly for a sliding door having two floor tracks.

FIG. 2 is similar to FIG. 1, but shows end caps of the exemplary weep sill assembly removed therefrom.

FIG. 3A is a top view of one of the exemplary end caps of FIG. 2.

FIG. 3B is a side elevation view of the exemplary end cap.

FIG. 3C is a bottom view of the exemplary end cap.

FIG. 3D is a rear end view of the exemplary end cap.

FIG. 4 is a partial perspective view of an exemplary sill roller cap of the weep sill assembly of FIGS. 1 and 2.

FIG. 5A is a partial perspective view of an exemplary recessed sill base of the weep sill assembly of FIGS. 1 and 2.

FIG. 5B is an end elevation view of the exemplary sill base.

FIG. 6 is a vertical cross-sectional view of a two-panel sliding door assembly including the weep sill assembly of FIGS. 1 and 2.

FIG. 7 is similar to FIG. 6 but shows a three-panel sliding door assembly rather than a two-panel sliding door assembly.

While the above-identified figures set forth one or more embodiments of the disclosed subject matter, other embodiments are also contemplated, as noted in the disclosure. In all cases, this disclosure presents the disclosed subject matter by way of representation and not limitation. It should be understood that numerous other modifications and embodiments can be devised by those skilled in the art which fall within the scope and spirit of the principles of this disclosure.

The figures may not be drawn to scale. In particular, some features may be enlarged relative to other features for clarity. Moreover, where terms such as above, below, over, under, top, bottom, side, right, left, etc., are used, it is to be understood that they are used only for ease of understanding the description. It is contemplated that structures may be oriented otherwise.

### DETAILED DESCRIPTION

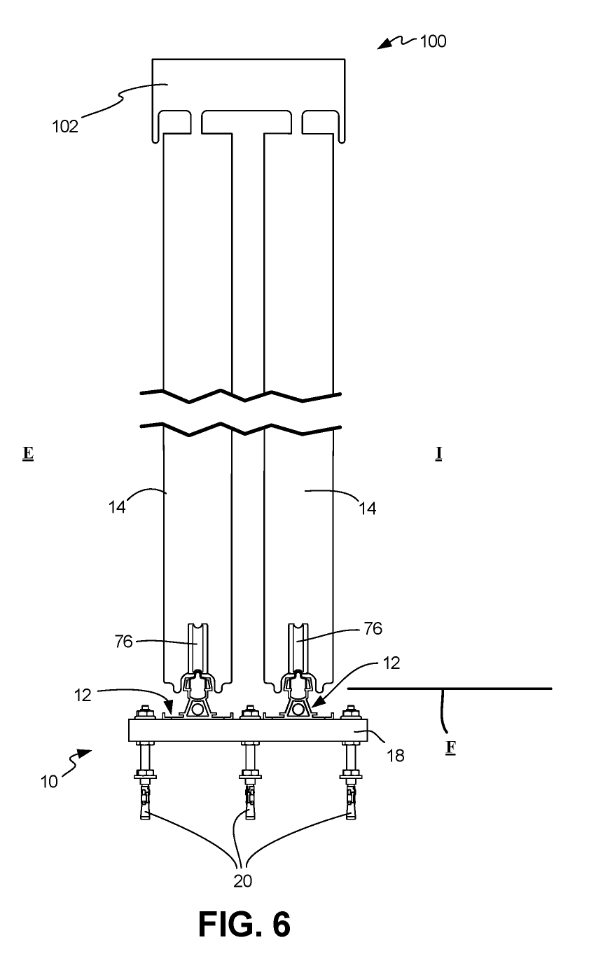

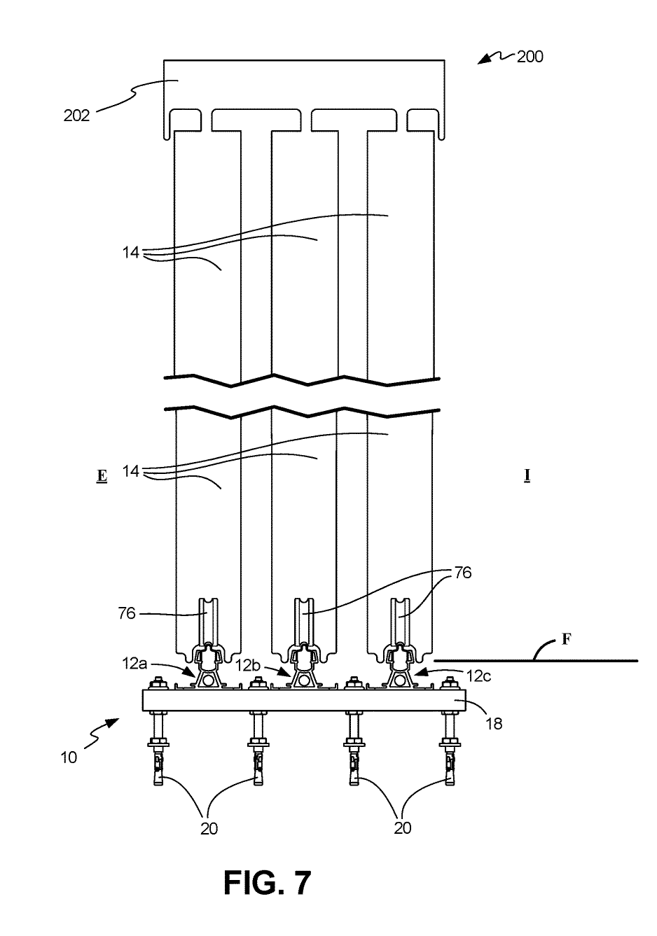

A drawback of typical weep sill assemblies is the limited volumetric capacity for water collection therein. The present disclosure is directed to a recessed weep sill assembly for use with sliding door panels, wherein the weep sill assembly provides a relatively large sill base interior area for fluid collection. A large portion of the structure of an exemplary weep sill assembly is recessed below a finished floor level in which the assembly is installed. For example, FIGS. 6 and 7 show the floor level F of a finished floor that is installed around the weep sill assembly 10 on an interior side I of a building. While not shown, it is to be understood that a flooring surface at a similar level is provided on the exterior side E of the building. However, the flooring surfaces and construction may differ on the interior and exterior sides I, E. For example, the floor on the interior side I may be polished hardwood nailed to a subfloor, while the floor on the exterior side E may be poured concrete.

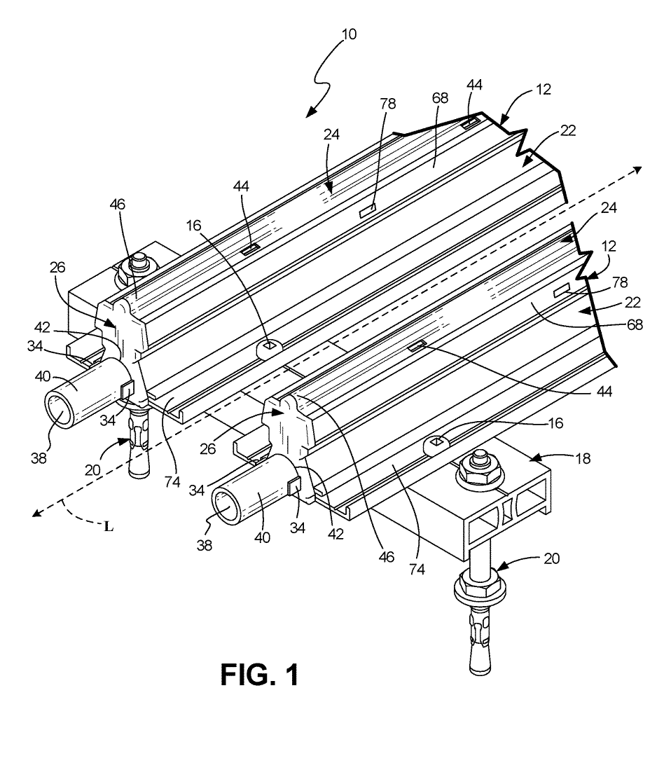

FIG. 1 is a partial perspective view of an end of an exemplary weep sill assembly 10. Weep sill assembly 10 includes an elongated horizontal track 12 corresponding to each door panel 14 (door panels 14 are shown in FIGS. 6 and 7). In an exemplary embodiment, each track 12 is attached, such as by fasteners 16, to a crossbar 18. Crossbar 18 is in turn fastened to subfloor structures such as concrete, structural joists, or the like (not shown) by fasteners 20. In an exemplary embodiment, crossbar 18 is an extruded metal member with a substantially hollow I-beam configuration, which provides strength, durability and lightness in weight.

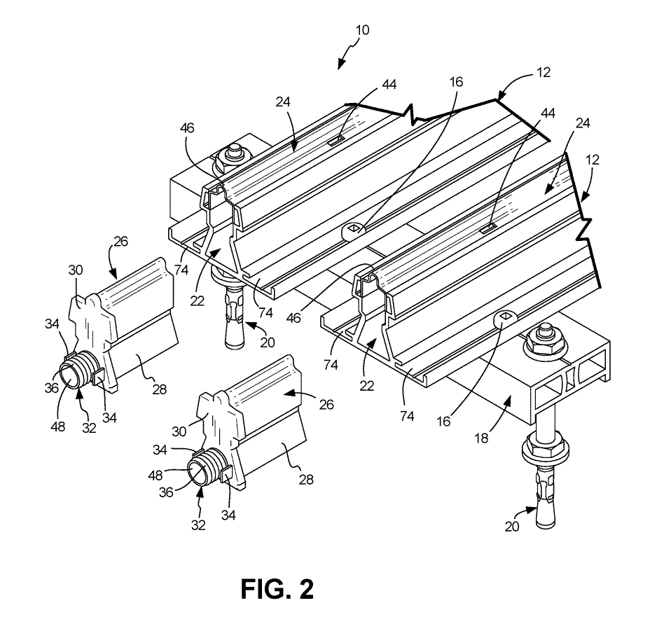

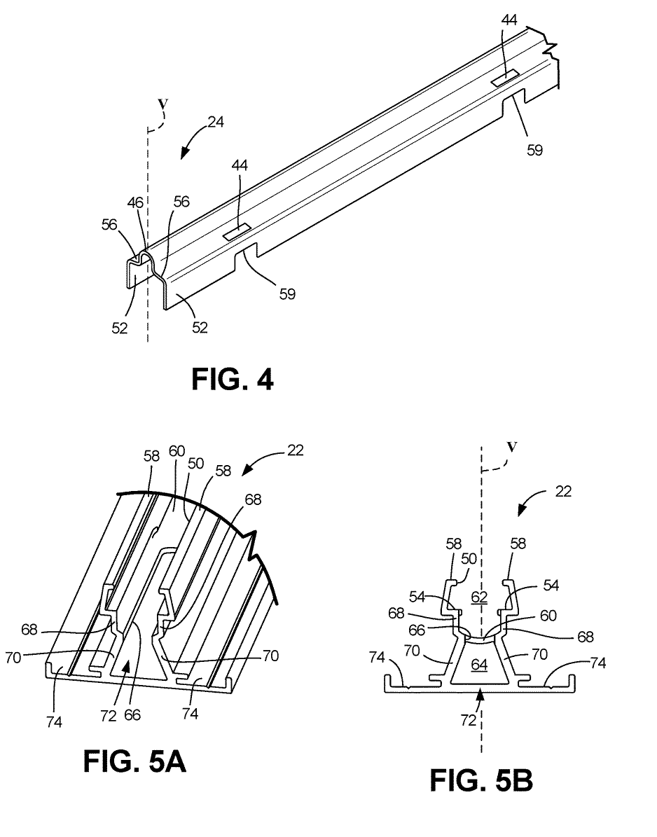

In an exemplary embodiment, each elongated track 12 includes an elongated sill base 22 (an end portion of which is shown separately in FIG. 5A) and a corresponding elongated sill roller cap 24 (an end portion of which is shown separately in FIG. 4). In an exemplary embodiment, each of the sill base 22 and sill roller cap 24 is elongated and has a length substantially corresponding to a horizontal length of the entire sliding door assembly. FIG. 6 is a vertical cross-sectional view of a two-panel sliding door assembly 100 including the weep sill assembly of FIGS. 1 and 2. FIG. 7 is similar to FIG. 6 but shows a three-panel sliding door assembly 200 rather than a two-panel sliding door assembly 100. In each of these drawings, door panels 14 and headers 102, 202 are shown schematically, in that details thereof are omitted for illustrational clarity.

In a two-panel sliding door assembly 100, such as shown in FIG. 6, each track 12 and thus its corresponding sill base 22 and sill roller cap 24 can have a length that is about twice a length of a single door panel 14. In another embodiment, such as the three-panel sliding door assembly 200 (shown in FIG. 7), each track 12 and its corresponding sill base 22 and sill roller cap 24 can have a length that is about three times a length of an individual door panel 14 (in a case where each of panels 14 can slide along an entire length of the sliding door assembly 200). For other sliding door assemblies, such as those having a combination of stationary and sliding door panels, it is contemplated that the length of each track 12 can be customized to offer the desired range of movement for each corresponding door panel 14. Moreover, in the case of the use of a weep sill assembly in a pocket door configuration, it is contemplated that track 12 may extend into a wall recess and therefore be even longer than a visible portion of a sliding door assembly when viewed from the interior or exterior of the building.

While a total length of a track 12 (and its corresponding sill base 22 and sill roller cap 24) has been discussed above for exemplary applications, it is to be understood that such a total length may be formed by connected sections of sill base 22 and sill roller cap 24 of shorter lengths. Accordingly, the components for forming track 12 may be delivered and stored in compact packages.

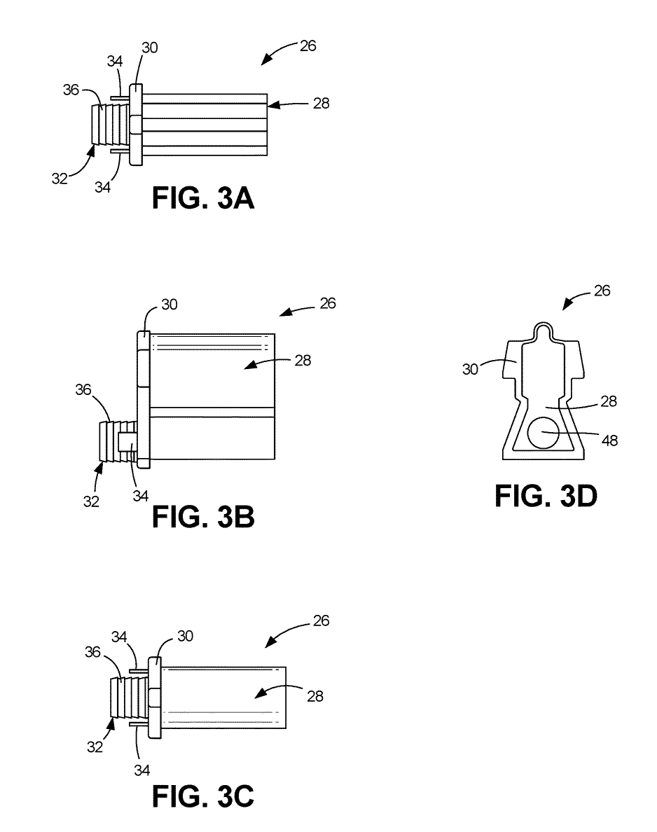

As shown in FIGS. 1 and 2, in an exemplary embodiment, an end of track 12 is closed by an end cap 26 configured for insertion into an end of the sill base 22 and sill roller cap 24. FIG. 3A is a top view of one of the exemplary end caps 26. FIG. 3B is a side elevation view of the exemplary end cap 26. FIG. 3C is a bottom view of the exemplary end cap 26. And FIG. 3D is a rear end view of the exemplary end cap 26. In an exemplary embodiment, each end cap 26 is integrally formed, such as by injection molding, from a polymeric material. However, other materials and manufacturing methods are also suitable.

End cap 26 includes insert 28 configured for insertion into, and frictional engagement with, interior surfaces of an end of sill base 22 and an end of sill roller cap 24. Insert 28 may be configured as a substantially solid plug (with a hole therethrough) or a hollow sleeve, for example. Insert 28 terminates in end plate 30, from which fitting 32 and flanges 34 extend in a direction opposite insert 28. In an exemplary embodiment, each fitting 32 is a substantially cylindrical tube having ribbing or other texture on an exterior surface 36 thereof, for frictional engagement with an interior surface 38 of drain conduit 40. In an exemplary embodiment, fitting 32 defines a port 48 therethrough. When end cap 26 is attached to track 12, as shown in FIG. 1, port 48 allows fluid communication between an interior of sill base 22 and drain conduit 40.

In FIG. 1, only a short segment of each drain conduit 40 is illustrated. However, it is to be understood that each drain conduit 40 is an elongated flexible hose or tubing section that directs fluid that has accumulated in sill base 22 to a collection reservoir or other location for removal from weep sill assembly 10. As shown in FIG. 1, a proximal end 42 of each drain conduit 40 is attached to end cap 26 by frictionally engaging end 42 between exterior surface 36 of fitting 32 and flanges 34. Additional or alternative attachment means can also be used at the interface of drain conduit 40 and end plate fitting 32, such as the use of adhesives, for example. Moreover, adhesive can also be used to secure insert 28 of end cap 26 into sill base 22 and sill roller cap 24.

As shown in FIG. 1, a length of weep sill assembly 10 is generally designated along longitudinal direction L. In an exemplary embodiment, sill roller cap 24 includes a plurality of longitudinally spaced apertures 44 on a top surface thereof. Apertures 44 allow for the passage of water and other fluids into the interior of sill base 22, for removal therefrom via drain conduit 40. As shown in FIGS. 6 and 7, weep sill assembly 10 is positioned at a threshold between an interior I of a building and an exterior E of the building. Rain, snow and fluids from other sources, such as swimming pools and garden hoses, for example, may be present on the exterior side E of weep sill assembly 10. To prevent an unchecked flow of such fluid into interior I of the building, apertures 44 are provided on one or both sides of ridge 46 of sill roller cap 24. Accordingly, weep sill assembly 10 performs a sealing function between the exterior E and interior I of the building to prevent outdoor fluids from entering the building. While each aperture 44 is illustrated as a substantially rectangular hole, it is contemplated that other configurations and locations may also be suitable. Moreover, while a number of discrete apertures 44 is illustrated, it is also contemplated that a more extensive arrangement of apertures, such as in a screen or mesh configuration, may also be suitable for sill roller cap 24.

While only one end of weep sill assembly 10 is illustrated, it is contemplated that the other end may be similarly configured. Alternatively, especially in a case where each track 12 is relatively short, it may be sufficient to provide drain conduits 40 at only one end of the weep sill assembly 10. In that case, the other end of the weep sill assembly 10 may be closed with end caps that include a solid end plate (without a port therethrough) and an insert 28, but without a fitting 32 or flanges 34. Especially in a case where drain conduit 40 is provided on only a single end of track 12, it is contemplated that track 12 can be slightly inclined so that a lower end of track 12 is proximate drain conduit 40, thereby facilitating the removal of collected fluid by gravity.

FIG. 4 is a partial perspective view of an exemplary sill roller cap 24. FIG. 5A is a partial perspective view of an exemplary recessed sill base 22. FIG. 5B is an end elevation of the exemplary sill base 22. In the illustrated embodiment, sill roller cap 24 and sill base 22 are symmetrical about a vertical line V (shown in FIGS. 4 and 5B). However, it is contemplated that other configurations are also suitable. As shown in FIGS. 2, 4, 5A and 5B, in an exemplary embodiment, sill roller cap 24 is removably insertable into top opening 50 of sill base 22. Top opening 50 is configured to allow for fluid ingress and for receiving side walls 52 of sill roller cap 24. Side walls 52 of sill roller cap 24 rest on shoulders 54 of sill base 22. Substantially lateral surfaces 56 of sill roller cap 24 are generally flush with flange 58 adjacent top opening 50.

As shown in FIGS. 5A and 5B, sill base 22 includes floor 60, which divides an interior space of sill base 22 into an upper chamber 62 and a lower chamber 64. Aperture or opening 66 in floor 60 allows for fluid communication between upper chamber 62 and lower chamber 64. In the illustrated embodiment, opening 66 is configured as an elongated slot proximate an end of sill base 22. However, it is contemplated that other openings having any size or shape can be provided in floor 60. Moreover, openings 66 may be positioned at discrete intervals along the longitudinal extent L of sill base 22 or may be located only near one or both ends of sill base 22.

Because of the fluid communication between upper chamber 62 and lower chamber 64 provided by opening 66, a large volumetric capacity is provided inside sill base 22 for the collection of fluid that can be drained from the weep sill assembly 10 through drain conduit 40. In an exemplary embodiment, openings 66 are sized and spaced so as to not compromise the structural integrity of floor 60, which connects to opposed upper walls 68 and corresponding lower walls 70 of sill base 22. In an exemplary embodiment, lower walls 70 are outwardly inclined from floor 60 toward a base floor 72 of sill base 22. Outwardly extending flanges 74, which extend from both lower walls 70, are substantially co-planar with base floor 72. As shown in FIGS. 1 and 2, sill base 22 may be attached to crossbar 18 via fasteners 16 through flanges 74 and, in turn, to a floor structure of the building. As shown in FIGS. 2-3D, an insert 28 of end cap 26 is configured to have a shape corresponding to the interior shape of sill roller cap 24, upper walls 68 and lower walls 70 of sill base 22.

As shown in FIG. 1, in an exemplary embodiment, an upper portion of upper wall 68 includes a weep hole 78. While only one weep hole 78 is illustrated in the portion of each sill base 22 shown in FIG. 1, it is to be understood that several such weep holes 78 may be provided at intervals along the longitudinal extent L. Moreover, as shown in FIG. 4, in an exemplary embodiment, notches 59 are provided at intervals along side wall 52 of sill roller cap 24. In case water seeps in between side wall 52 of sill roller cap 24 and flange 58 of sill base 22—or through weep holes 78—the water can flow through notch 59 and into upper chamber 62. In an exemplary embodiment, weep holes 78 are provided only on the upper wall 68 on the exterior side of sill base 22 (e.g., the upper wall 68 facing the exterior of the building E, as shown in FIGS. 6 and 7). Similarly, notches 59 of sill roller cap 24 may be provided only on the exterior side of the sill roller cap 24. Referring to FIG. 7, in some uses, it is desirable to use a sill base 22 and sill roller cap 24 having weep holes 78, notches 59 and apertures 44 on only the exterior sides thereof for tracks 12a and 12b (exterior and middle tracks). However, a double-sided sill base 22 and a double-sided sill roller cap 24 having weep holes 78, notches 59 and apertures 44 on both the exterior and interior sides thereof can be used for the inner-most track 12c to offer additional drainage opportunities for fluid that may be directed toward the interior I of the building.

In an exemplary embodiment, each track 12 is connected to an individual drain conduit 40. Fluid that has collected in lower chamber 64 (and also in upper chamber 62, if applicable) is drained from weep sill assembly 10 through drain conduits 40 that are attached to end cap 26. However, it is also contemplated that in an alternative or additional arrangement, drain conduit 40 can be attached to side fittings similar to fitting 32 provided on lower wall 70 of sill base 22, or to bottom fittings similar to fitting 32 provided on base floor 72 of sill base 22. In those cases, transversely oriented drain conduits or bottom drain-type conduits can remove collected fluid from weep sill assembly 10, such as in cases where space for such drain conduits is not available at one or both ends of the weep sill assembly. Moreover, tracks 12 may be connected by a fluid manifold that functions to drain fluid from all of the connected tracks 12.

As shown in FIGS. 6 and 7, each of two-panel sliding door assembly 100 and three-panel sliding door assembly 200 includes a plurality of door panels 14. A top portion of each door panel 14 is attached to the building wall at header 102, 202. While two and three door panels 14 are shown, it is contemplated that the disclosed weep sill assembly 10 may be modified for use in a sliding door assembly having fewer or more door panels. The door panels 14 are configured for slidable engagement with header 102, 102 and weep sill assembly 10 along longitudinal extent L. In an exemplary embodiment, a bottom portion of each door panel 14 incorporates wheels 76 configured for rolling engagement with ridge 46 of sill roller cap 24. It is contemplated that other cooperative structures of door panel 14 and sill roller cap 24 can also be provided, including but not limited to nearly frictionless surfaces and ball bearings, for example. In an exemplary embodiment, sill roller cap 24 is formed from a material such as hardened, anodized aluminum or stainless steel. In an exemplary embodiment, sill base 22 is formed from an extruded metal, such as aluminum. However, it is contemplated that other materials and manufacturing methods for components of weep sill 10 are also suitable.

Although the subject of this disclosure has been described with reference to several embodiments, workers skilled in the art will recognize that changes may be made in form and detail without departing from the spirit and scope of the disclosure. For example, while tracks 12 and door panels 14 are illustrated as generally straight structures, it is contemplated that weep sill assembly 10 and the sliding door assemblies 100, 200 can be modified for curved, slidable door panels. Moreover, the disclosed weep sill assembly can also be used in sliding window assemblies. In addition, any feature disclosed with respect to one embodiment may be incorporated in another embodiment, and vice-versa.

What is claimed is:

1. A weep sill assembly including:
an elongated sill base including a top opening configured for fluid ingress;
a first floor within the sill base that divides an interior of the sill base into an upper chamber and a lower chamber, wherein the floor includes a first aperture that provides fluid communication between the upper chamber and the lower chamber; and
a drain conduit in fluid communication with the lower chamber.

2. The weep sill assembly of claim 1 further including:
a sill roller cap disposed in the top opening.

3. The weep sill assembly of claim 2, wherein the sill roller cap includes a plurality of second apertures configured for fluid ingress.

4. The weep sill assembly of claim 2 further including an end cap configured for attachment to an end of the sill base.

5. The weep sill assembly of claim 4, wherein the end cap includes an insert configured for insertion into the end of the sill base.

6. The weep sill assembly of claim 4, wherein the sill base includes two opposed upper walls and two opposed lower walls, and wherein the insert is configured to have a shape corresponding to an interior of the sill roller cap and an interior of the upper walls and an interior of the lower walls.

7. The weep sill assembly of claim 4, wherein the end cap includes a port that provides for fluid communication between the drain conduit and the lower chamber.

8. The weep sill assembly of claim 1, wherein the first aperture is an elongated slot located proximate an end of the sill base.

9. The weep sill assembly of claim 1, further including a second floor that defines a bottom of the lower chamber.

10. The weep sill assembly of claim 9, wherein the sill base further includes:
two opposed lower walls; and
a flange that extends from one of the lower walls and is co-planar with the second floor.

11. A sliding door assembly including:
a header configured for attachment to a wall;
a weep sill assembly including:
an elongated sill base including a top opening configured for fluid ingress;
a first floor within the sill base that divides an interior of the sill base into an upper chamber and a lower chamber, wherein the floor includes a first aperture that provides fluid communication between the upper chamber and the lower chamber; and
a drain conduit in fluid communication with the lower chamber; and
a door panel configured for slidable engagement with the header and with the weep sill assembly.

12. The sliding door assembly of claim 11 further including a sill roller cap disposed in the top opening and including a ridge, wherein the door panel further includes a wheel configured for rolling engagement with the ridge.

13. The sliding door assembly of claim 12, wherein the sill roller cap includes a plurality of second apertures configured for fluid ingress.

14. The sliding door assembly of claim 12 further including an end cap configured for attachment to an end of the sill base.

15. The sliding door assembly of claim 14, wherein the end cap includes an insert configured for insertion into the end of the sill base.

16. The sliding door assembly of claim 14, wherein the sill base includes two opposed upper walls and two opposed lower walls, and wherein the insert is configured to have a shape corresponding to an interior of the sill roller cap and an interior of the upper walls and an interior of the lower walls.

17. The sliding door assembly of claim 14, wherein the end cap includes a port that provides for fluid communication between the drain conduit and the lower chamber.

18. The sliding door assembly of claim 11, wherein the first aperture is an elongated slot located proximate an end of the sill base.

19. The sliding door assembly of claim 11, further including a second floor that defines a bottom of the lower chamber.

20. The sliding door assembly of claim 19, wherein the sill base further includes:
two opposed lower walls; and
a flange that extends from one of the lower walls and is co-planar with the second floor.
